(19) United States
(12) Patent Application Publication
(10) Pub. No.: US 2019/0267179 A1
(43) Pub. Date: Aug. 29, 2019

(54) ELECTROMAGNETIC APPARATUS

(71) Applicant: FANUC CORPORATION, Yamanashi (JP)

(72) Inventor: Shouhei Kobayashi, Yamanashi (JP)

(73) Assignee: FANUC CORPORATION, Yamanashi (JP)

(21) Appl. No.: 16/286,710

(22) Filed: Feb. 27, 2019

(30) Foreign Application Priority Data
Feb. 28, 2018 (JP) 2018-034779

(51) Int. Cl. H01F 27/26; H01F 27/28

(52) U.S. Cl. CPC H01F 27/26; H01F 27/28

(57) ABSTRACT

An electromagnetic apparatus includes an outer peripheral iron core, at least three leg iron cores arranged at intervals in a circumferential direction on an inner face side of the outer peripheral iron core, and a coil wound around each leg iron core, wherein the at least three leg iron cores are arranged such that one end of each leg iron core in a direction of a winding axis of the coil is magnetically coupled with the outer peripheral iron core, and the other end of each leg iron core is magnetically coupled with the other ends of other leg iron cores, and the outer peripheral iron core includes a recess recessed toward the inner face side on an outer face side thereof in a section corresponding to space between adjacent two leg iron cores in the circumferential direction.

### BACKGROUND OF THE INVENTION

### 1. Field of the Invention

The present invention relates to an electromagnetic apparatus, e.g., a three-phase transformer, a single-phase transformer, and the like.

### 2. Description of the Related Art

In the related art, a transformer that includes a U-shaped or E-shaped iron core and a coil wound around the iron core is used. In such a transformer, the coil is exposed to the outer side of the transformer, and therefore flux may leak from the coil. The flux leakage may generate an eddy current in a metal section in the vicinity of the coil and thereby cause the metal section of the transformer to generate heat. Generally, the aforementioned flux leakage is suppressed by arranging a shield plate in the vicinity of the coil (e.g., see JP 05-52650 B).

In addition, in the transformer, it is preferable to reduce the volume or weight of the iron core as much as possible. In this respect, e.g., in JP 2014-204120 A, it is described that “since the iron core requires, as components, only three block iron cores 11 formed in the same shape, the number of components can be reduced and manufacturability can be improved, compared with a Y-type iron core 7 in the related art that requires three block iron cores 5 and two center yokes 6” (see paragraph [0017]).

### SUMMARY OF THE INVENTION

In an electromagnetic apparatus such as a transformer, it is desirable to have a configuration capable of suppressing flux leakage from a coil and reduce the volume or weight of an iron core.

One aspect of the present disclosure is an electromagnetic apparatus including an outer peripheral iron core, at least three leg iron cores configured to be arranged at intervals in a circumferential direction on an inner face side of the outer peripheral iron core, and a coil configured to be wound around each of the at least three leg iron cores, wherein the at least three leg iron cores are arranged such that one end of each of the at least three leg iron cores in a direction of a winding axis of the coil is magnetically coupled with the outer peripheral iron core, and other end of each of the at least three leg iron cores in the direction of the winding axis is magnetically coupled with other ends of other leg iron cores among the at least three leg iron cores, and wherein the outer peripheral iron core includes, on an outer face side thereof, a recess that is recessed toward the inner face side of the outer peripheral iron core in a section corresponding to space between adjacent two leg iron cores in the circumferential direction among the at least three leg iron cores.

### BRIEF DESCRIPTION OF THE DRAWINGS

The objects, features and advantages of the invention will become more apparent from the following description of the embodiments in connection with the accompanying drawings, wherein:

FIG. 1A is a perspective view of an electromagnetic apparatus according to a first embodiment;

FIG. 1B is a plan view in a case where the electromagnetic apparatus in FIG. 1A is viewed from above;

FIG. 1C illustrates a cross-sectional view of one of the iron core coils of the electromagnetic apparatus in FIG. 1A in a case where one iron core coil is cut along a plane perpendicular to a central axis of the iron core coil;

FIG. 2 is a view illustrating an iron core section of the electromagnetic apparatus in FIG. 1A;

FIG. 3 is a view to explain a method of taking out an iron core of each layer constituting the iron core section in FIG. 2 from a sheet of steel plate;

FIG. 4 is a view illustrating an example of a shape of the iron core section in a case where a width in the direction perpendicular to the axis of a coil is wider than that of the iron core section in FIG. 3, and explaining a method of taking out this iron core section from a sheet of steel plate;

FIG. 5A is a perspective view of an electromagnetic apparatus according to a second embodiment;

FIG. 5B is a plan view of the electromagnetic apparatus according to the second embodiment;

FIG. 6 is an exploded view illustrating a state where the electromagnetic apparatus in FIG. 5A is assembled on a fixation frame;

FIG. 7 is a perspective view illustrating a state where the electromagnetic apparatus in FIG. 5A has been assembled on the fixation frame;

FIG. 8 is a view illustrating an example where the electromagnetic apparatus according to the first embodiment and the second embodiment is used as a three-phase transformer;

FIG. 9 is a plan view of an electromagnetic apparatus viewed from above according to a third embodiment;

FIG. 10A is a cross-sectional view illustrating the configuration of an electromagnetic apparatus as a reference example; and

FIG. 10B is a view illustrating the iron core section of the electromagnetic apparatus in FIG. 10A.

### DETAILED DESCRIPTION

Embodiments of the present invention will be described below with reference to the accompanying drawings. Throughout the drawings, corresponding components are denoted by common reference numerals. To facilitate the understanding of the drawings, scales of the drawings are appropriately changed. Note that modes illustrated in the drawings are merely examples to implement the invention, and the invention is not limited to the modes illustrated.

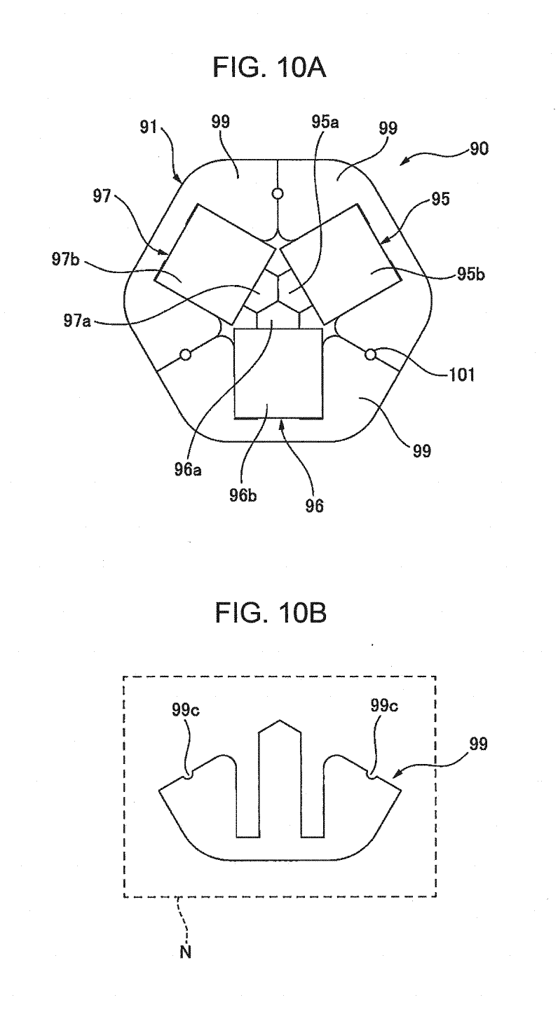

The configuration of an electromagnetic apparatus as a reference example will be described with reference to FIGS. 10A and 10B prior to the explanation of embodiments of the present invention. In an electromagnetic apparatus using an E-type iron core used in the related art, there is a problem that an eddy current is generated by flux leakage from a coil in a metal section in the vicinity of the coil, thereby causing the metal section of the electromagnetic apparatus to generate heat. FIGS. 10A and 10B are reference drawings illustrating an example of an electromagnetic apparatus 90 configured to solve the aforementioned problem. FIG. 10A is a plan view illustrating the electromagnetic apparatus 90 viewed from above. The electromagnetic apparatus 90 is used as a three-phase transformer as one example. The electromagnetic apparatus 90 includes an outer peripheral iron core 91 having a hexagonal exterior in a planar view of FIG. 10A and three iron core coils 95 to 97 arranged on the inner side of the outer peripheral iron core 91. The three iron core coils 95 to 97 have the identical size and shape and are arranged at regular intervals in the circumferential direction around the center of the outer peripheral iron core 91 in a planar view of FIG. 10A.

The three iron core coils 95 to 97 respectively have iron cores 95a to 97a and coils 95b to 97b wound around the iron cores 95a to 97a. Each of the coils 95b to 97b may include both a primary coil and a secondary coil. The three iron core coils 95 to 97 are arranged on the inner side of the outer peripheral iron core 91 in such a manner as to be surrounded by the cuter peripheral iron core 91. Thus, the configuration in which the three iron core coils are surrounded by the outer peripheral iron core 91 is provided, thereby preventing magnetic flux from each of the coils 95b to 97b from being leaked to the outer side of the outer peripheral iron core 91.

As illustrated in FIG. 10A, iron cores constituting the electromagnetic apparatus 90 are formed of three iron core sections 99 having the identical size and shape. That is, the electromagnetic apparatus 90 is configured by joining the three iron core sections 99 having a shape illustrated in FIG. 10B. Thus, the iron core is configured to be divided into three sections, which makes it possible to efficiently assemble the electromagnetic apparatus 90. It is noted that each iron core section 99 may be such that notches 99c are formed on side sections of both ends so as to form through-holes 101 for mounting on a casing frame when the iron core sections 99 are assembled as the electromagnetic apparatus 90.

As illustrated in FIG. 10A, the iron cores 95a to 97a respectively constituting the iron core coils 95 to 97 are configured to extend from the outer peripheral iron core 91 along the central axes of the coils 95b to 97b and join each other in the center of the outer peripheral iron core 91. With the aforementioned configuration, an advantage that the lengths of magnetic paths of three phases are structurally identical in the case where the electromagnetic apparatus 90 is used as a three-phase transformer is obtained.

Hereinafter, the configuration of an electromagnetic apparatus according to embodiments of the present invention will be described while appropriately comparing with the electromagnetic apparatus 90 as a reference example illustrated in the aforementioned reference drawings, FIGS. 10A and 10B. The electromagnetic apparatus according to the embodiments of the present invention is, e.g., a transformer, a reactor, and the like.

### First Embodiment

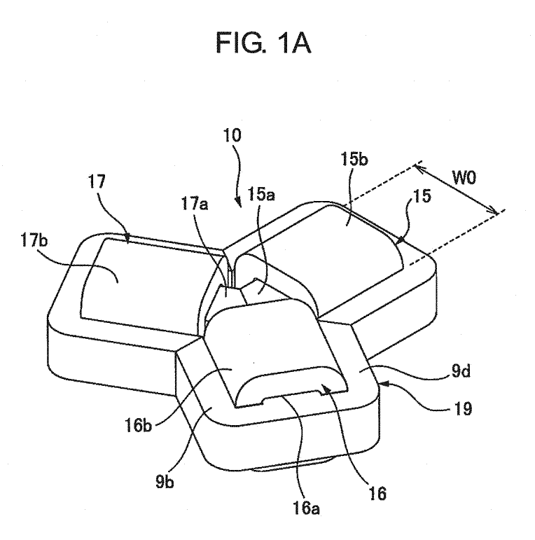

FIG. 1A is a perspective view of an electromagnetic apparatus 10 according to a first embodiment, and FIG. 1B is a plan view in a case where the electromagnetic apparatus 10 is viewed from above. It is noted that the electromagnetic apparatus 10 is used as a multiphase transformer (specifically, three-phase transformer), and thus hereinafter referred to as a multiphase transformer 10.

As illustrated in FIGS. 1A and 1B, the multiphase transformer 10 includes an outer peripheral iron core 19 and three iron core coils 15 to 17 arranged on the inner side of the outer peripheral iron core 19. The three iron core coils 15 to 17 respectively include iron cores 15a to 17a and coils 15b to 17b wound around the iron cores 15a to 17a. Each of the coils 15b to 17b may include both a primary coil and a secondary coil.

The three iron core coils 15 to 17 have the identical size and shape and are arranged at regular intervals in the circumferential direction around the center P of the outer peripheral iron core 19 on the inner side of the outer peripheral iron core 19. In this case, two adjacent center axes l₀ among the center axes (winding axes) l₀ of the three iron core coils 15 to 17 are intersected at the center P to form an angle of 120 degrees. In addition, a tip end on the side of the center P of each of the iron cores 15a to 17a extended along the center axes l₀ of the three iron core coils 15 to 17 has a shape that converges to the center P, and the tip end forms an angle of approximately 120 degrees. Thus, the configuration in which the three iron core coils 15 to 17 are surrounded by the outer peripheral iron core 19 is provided, thereby preventing magnetic flux from each of the coils 15b to 17b from being leaked to the outer side of the outer peripheral iron core 19. Consequently, necessity to arrange a shield plate on the outer side of the multiphase transformer 10 can be eliminated, and a reduction in cost can be achieved.

In the case where the multiphase transformer 10 having the aforementioned configuration has been used as a three-phase transformer, there is an advantage in that the lengths of magnetic paths of three phases are structurally identical.

In FIG. 1B, the hexagonal exterior (a polygon formed by virtually connecting corners positioned on the outer circumference of a cross section defined by cutting the outer peripheral iron core 19 along a plane parallel to the extending directions of the iron core coils 15 to 17) of the electromagnetic apparatus 90 in the reference example illustrated in FIG. 10A is illustrated with a dashed line D. As illustrated in FIG. 1B, the multiphase transformer 10 according to the first embodiment includes recesses 19r corresponding to a shape in which, among sides of the polygon (hexagon) that is formed by connecting the six corners 19a to 19f of the exterior of the outer peripheral iron core 19 as the dashed line D, a side connecting adjacent iron core coils is recessed toward the center P. It is understood that, with this configuration, the cross-sectional area of the iron core viewed on the cross section defined by cutting the outer peripheral iron core 19 along a plane parallel to the extending directions of the iron core coils 15 to 17 (see FIG. 1B) has been considerably reduced, compared with the case of the reference example of FIG. 10A. That is, the volume and weight of the iron core of the multiphase transformer can be reduced. It is noted that the outer peripheral iron core 19 has a uniform thickness T in a planar view in FIG. 1B, and surrounds each of the iron core coils 15 to 17 while closely contacting the outer side of each of the iron core coils 15 to 17. Thus, the leakage of magnetic flux from each of the iron core coils 15 to 17 to the outer side of the outer peripheral iron core 19 can be securely suppressed. It is noted that the outer face of the outer peripheral iron core 19 is formed to have a large surface area, compared with the outer circumferential face of the outer peripheral iron core 99 in the reference example of FIG. 10A, which is advantageous in terms of dissipation of heat, compared with the electromagnetic apparatus 90 in the reference example of FIG. 10A.

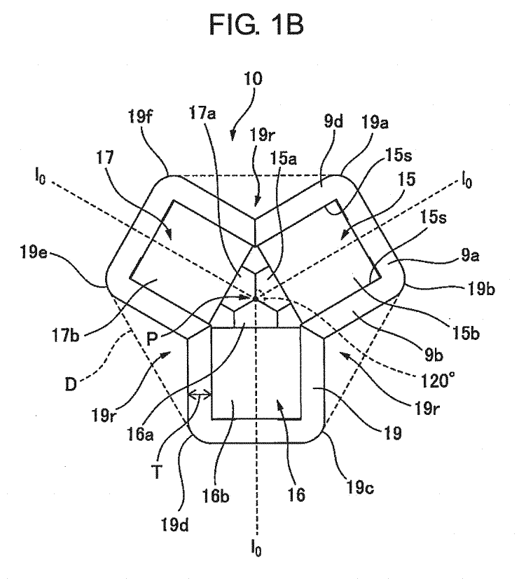

FIG. 1C illustrates a cross-sectional view defined when one of the iron core coils 15 to 17 is cut along a plane perpendicular to the central axis l₀ of the iron core coil. In the outer peripheral iron core 19, a section (a side section 9b or 9d in FIG. 2 described later) which forms the recess 19r and which is formed along the side face 15s of each of the iron core coils 15 to 17 is formed in such a manner that the cross-sectional area S defined when the section is cut along an arbitrary plane perpendicular to the side face 15s is the same (i.e., the cross-sectional area S is constant).

As illustrated in FIGS. 1A and 1B, the iron core constituting the multiphase transformer 10 is formed of three iron core sections 9 having the identical size and shape. That is, the multiphase transformer 10 is configured by joining the three iron core sections 9 having a shape illustrated in FIG. 2. Thus, the outer peripheral iron core 19 is configured to be divided into three sections, which makes it possible to efficiently assemble the multiphase transformer 10. As illustrated in FIG. 2, the iron core section 9 includes an approximately rectangular cylindrical base 9a, side sections 9b and 9d protruding in the same direction in such a manner as to form a right angle with respect to the base 9a from both ends in the longitudinal direction of the base 9a, and a central leg section 9c protruding in the same direction as that of the side sections 9b and 9d from the center in the longitudinal direction of the base 9a. The central leg section 9c constitutes each of the iron cores 15a to 17a of the iron core coils 15 to 17 of the multiphase transformer 10. In addition, the base 9a and both side sections 9b and 9d constitute the outer peripheral iron core 19 of the multiphase transformer 10. In FIG. 1B, the base 9a of each iron core section 9 has a shape that linearly extends along the circumferential direction in which the iron core coils 15 to 17 are arranged.

The both side sections 9b and 9d and the tip section of the central leg section 9c form part of the sides of a triangle illustrated in a dashed line L in FIG. 2. It is noted that, as described above, the tip section 9f of the central leg section 9c converges to form an angle of 120 degrees. With this configuration, as illustrated in FIG. 1B, it is possible for the three iron core sections 9 to closely contact to each other by joining both side sections 9b and 9d of the three iron core sections 9 with respect to each other and joining the tip sections 9f of the central leg sections 9c of the three iron core sections 9 with respect to each other. It is noted that as one example, respective widths dO of both side sections 9b and 9d may be one half the size of the width dl of the central leg section 9c.

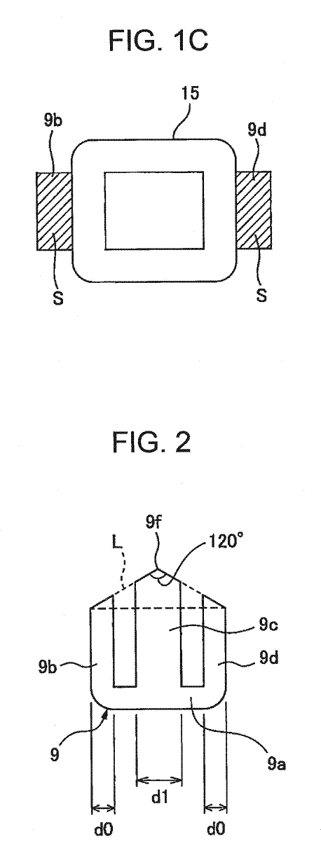

Each iron core section 9 is configured by stacking, for example, a plurality of steel plates, carbon steel plates, or electromagnetic steel plates. FIG. 3 is a view to explain a method of taking out an iron core of each layer constituting the iron core section 9 in FIG. 2 from a sheet of steel plate. As illustrated in FIG. 2, each iron core section 9 is configured such that the both side sections 9b and 9d and the central leg section 9c form a right angle with respect to the base 9a and that the tips of the both side sections 9b and 9d and the tip of the central leg section 9c form part of the sides of a triangle. Consequently, as illustrated in FIG. 3, an upper row L1 of the iron core sections 9 and a lower row L2 of the iron core sections 9 can be punched and cut from a steel plate in a state of arrangement where the tips of the rows are opposite to each other and the rows are arranged in a closely contact state while being shifted to each other by a half of the width M of the iron core section 9 in a lateral direction in FIG. 3. Thus, the utilization rate of the steel plate can be increased. In contrast, in the case of the iron core section 99 of the reference example illustrated in FIG. 10B, it is necessary to punch out the iron core section 99 from a steel plate in a rectangular shape as illustrated in a dashed line N in FIG. 10B, and it is understood that the shape of the iron core section 9 of the present embodiment can significantly improve the utilization rate of the steel plate.

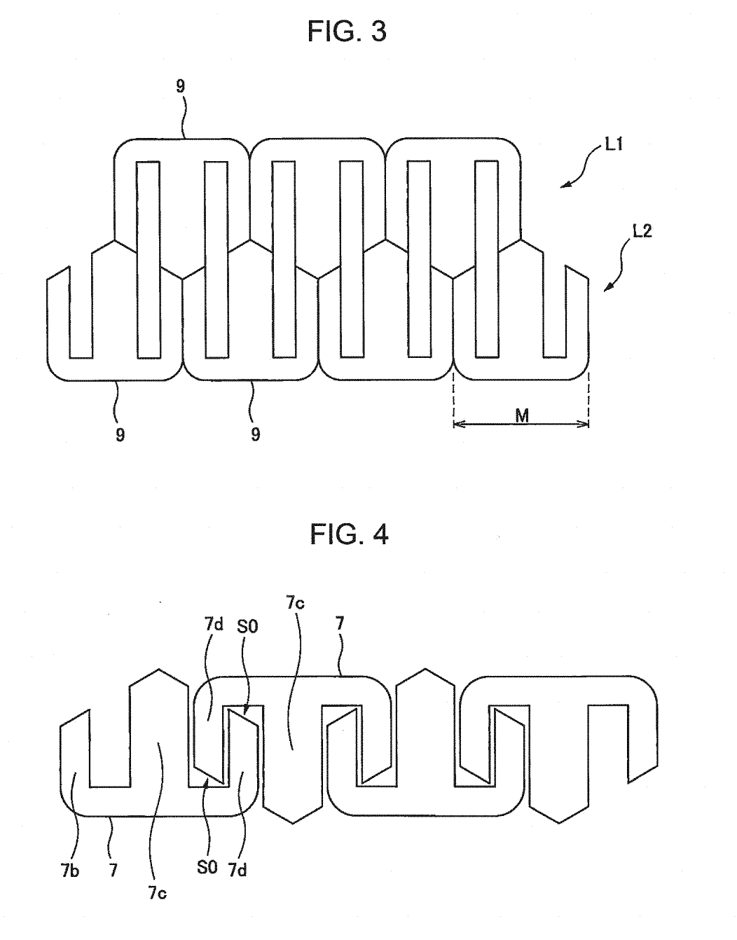

FIG. 4 is a view illustrating an example of a shape of an iron core section 7 in a case where a width in the direction perpendicular to the axis of a coil is wider than the width W0 illustrated in FIG. 1A and explaining a method of taking out this iron core section 7 from a sheet of steel plate. The width of a gap S0 between a central leg section 7c and both side sections 7b and 7d of the iron core section 7 illustrated in FIG. 4 is wider than the width of the both side sections 7b and 7d. In this case, each iron core section 7 can be punched out from the steel plate in a state of arrangement in which the tip ends of the adjacent iron core sections 7 face the directions opposite to each other, and respective side sections (7d, 7d) of the adjacent iron core sections 7 mutually fit in the gaps S0 each formed between the central leg section 7c and the side section 7d. Similarly in this case, it is understood that the utilization rate can be significantly improved, compared with the method of punching out the iron core section 99 of the reference example illustrated in FIG. 10B.

It is noted that through-holes for attachment to a fixation frame (not illustrated) may be formed in the multiphase transformer 10.

### Second Embodiment

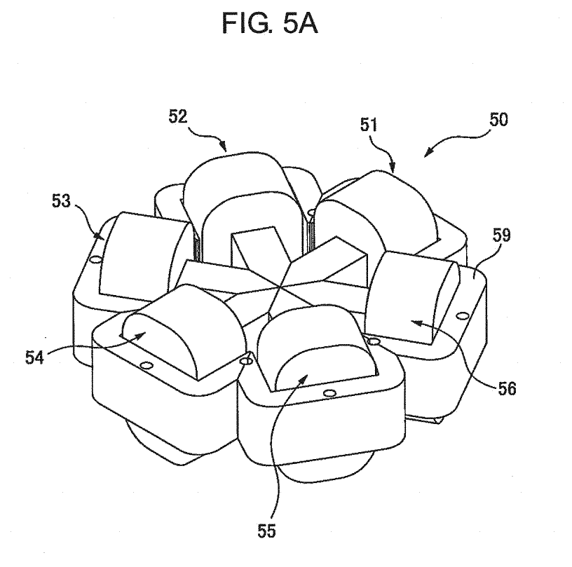

Hereinafter, the configuration of a multiphase transformer 50 according to a second embodiment will be described. The multiphase transformer 50 according to the second embodiment is configured such that the number of iron core coils of the multiphase transformer 10 of the first embodiment is increased to six, and the basic concept of configuration is similar to that of the first embodiment. FIG. 5A is a perspective view of the multiphase transformer 50, and FIG. 5B is a plan view of the multiphase transformer 50.

As illustrated in FIGS. 5A and 5B, the multiphase transformer 50 includes an outer peripheral iron core 59 and six iron core coils 51 to 56 arranged on the inner side of the outer peripheral iron cores 59. The six iron core coils 51 to 56 each include iron cores 51a to 56a and coils 51b to 56b wound around the iron cores 51a to 56a. Each of the coils 51b to 56b may include both a primary coil and a secondary coil.

The six iron core coils 51 to 56 have the identical size and shape and are arranged at regular intervals in the circumferential direction around the center P of the outer peripheral iron core 59 on the inner side of the outer peripheral iron core 59. In this case, two adjacent center axes l₀ among the center axes l₀ of the six iron core coils 51 to 56 are intersected at the center P to form an angle of 60 degrees. In addition, a tip end on the side of the center P of each of the iron cores 51a to 56a extended along the center axes l₀ of the six iron core coils 51 to 56 has a shape that converges to the center P, and the tip end forms an angle of approximately 60 degrees. Thus, the configuration in which the six iron core coils 51 to 56 are surrounded by the outer peripheral iron core 59 is provided, thereby preventing magnetic flux from each of the coils 51b to 56b from being leaked to the outer side of the outer peripheral iron core 59. Consequently, necessity to arrange a shield plate on the outer side of the multiphase transformer 50 can be eliminated, and a reduction in cost can be achieved.

Thus, when the multiphase transformer 50 includes the iron core coils whose number is a multiple of three, the multiphase transformer 50 can be used as a three-phase transformer. In this case, each coil can be connected in series or parallel. Similarly, in the present embodiment, an effect that the lengths of magnetic paths of three phases are structurally identical can be obtained.

As illustrated in FIG. 5B, the multiphase transformer 10 according to the second embodiment includes recesses 59r corresponding to a shape in which, among sides of the polygon (dodecagon) that is formed by connecting the twelve corners of the exterior of the outer peripheral iron core 59 as the dashed line E, a side connecting adjacent iron core coils is recessed toward the center P. It is understood that, with this configuration, the cross-sectional area of the iron core viewed on the cross section defined by cutting the outer peripheral iron core 59 along a plane parallel to the extending directions of the iron core coils 51 to 56 (see FIG. 5B) has been considerably reduced, compared with the case where the outer peripheral iron core 59 has a polygonal cross-sectional shape depicted by the dashed line E. That is, the volume and weight of the iron core of the multiphase transformer can be reduced. It is noted that the outer peripheral iron core 59 has a uniform thickness T2 in a planar view in FIG. 5B, and surrounds each of the iron core coils 51 to 56 while closely contacting the outer side of each of the iron core coils 51 to 56. Thus, the leakage of magnetic flux from each of the iron core coils 51 to 56 to the outer side of the outer peripheral iron core 59 can be securely suppressed. It is noted that the outer face of the outer peripheral iron core 59 is formed to have a large surface area, compared with the outer circumferential face of the polygon defined by the dashed line E in FIG. 5B, which is advantageous in terms of dissipation of heat.

As is the case with FIG. 1C, in the outer peripheral iron core 59, a section (a side section 61b or 61d) which forms the recess 59r and which is formed along the side face 51s of each of the iron core coils 51 to 56 is formed in such a manner that the cross-sectional area defined when the section is cut along an arbitrary plane perpendicular to the side face 51s is the same.

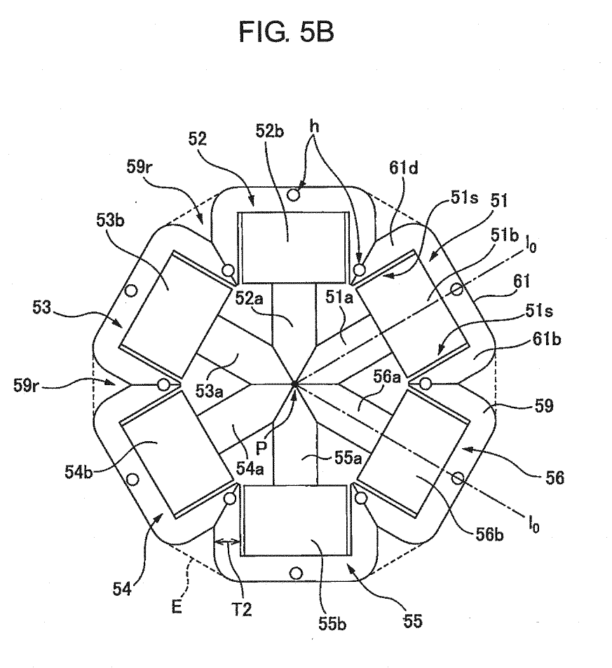

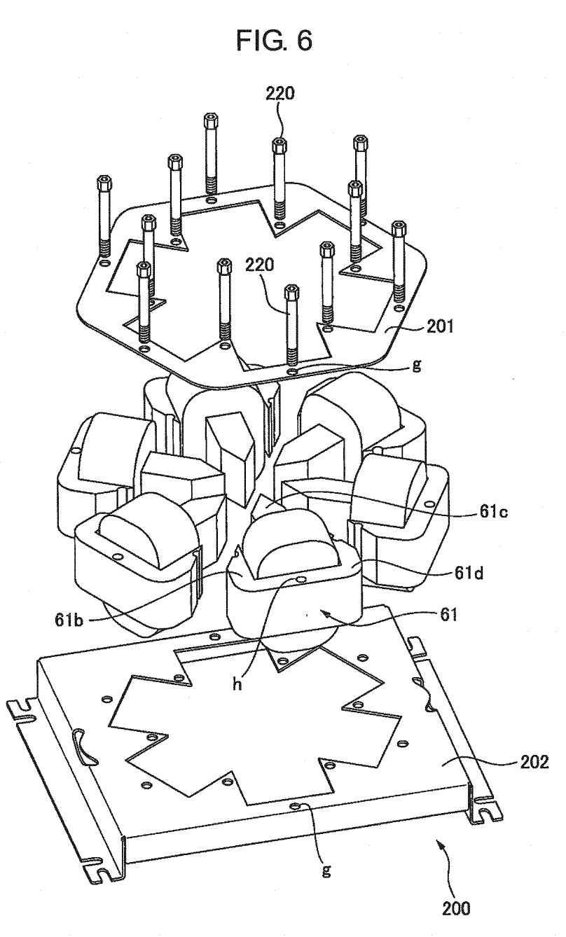

As illustrated in FIG. 5B, the iron core constituting the multiphase transformer 50 are configured to be divided into six sections. Each iron core section 61 includes side sections 61b and 61d and a central leg section 61c that protrude in the same direction with respect to the base (see FIG. 6). Thus, the outer peripheral iron core 59 is configured to be divided, which makes it possible to efficiently assemble the multiphase transformer 50. Herein, the assembly structure of the multiphase transformer 50 will be described with reference to FIGS. 6 and 7. FIG. 6 is an exploded view illustrating a state where the multiphase transformer 50 is assembled on a fixation frame 200. FIG. 7 is a perspective view illustrating a state where the multiphase transformer 50 has been assembled on the fixation frame 200.

As illustrated in FIG. 6, the fixation frame 200 includes an upper frame 201 and a lower frame 202 that sandwich and fix the outer peripheral iron core 59 from above and below. Each iron core section 61 is positioned by aligning holes g formed in the upper frame 201 and the lower frame 202 with a through-hole h formed in each iron core section 59, and is fixed to the upper frame 201 and the lower frame 202 with a bolt 220 (see FIG. 7). With this configuration, the multiphase transformer 50 is firmly fixed on the fixation frame 200.

As for the multiphase transformer 50 of the second embodiment, the same effect as that of the multiphase transformer 10 of the first embodiment can be obtained.

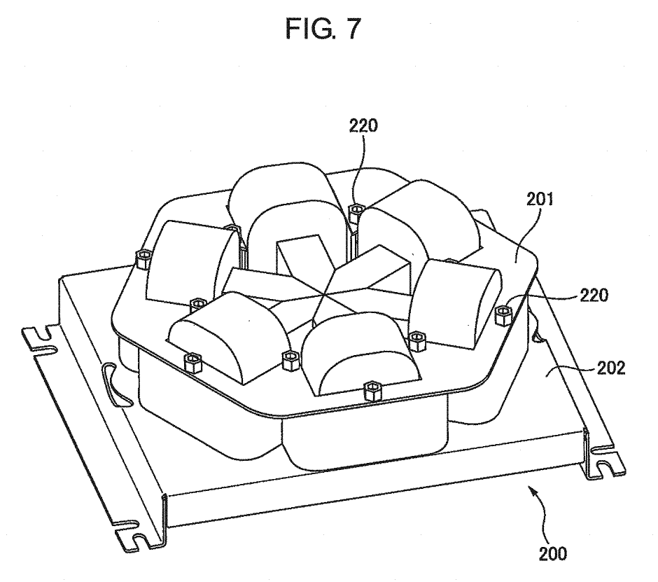

FIG. 8 is a view illustrating an example of use of the aforementioned multiphase transformer 10 and multiphase transformer 50 used as a three-phase transformer. As illustrated in FIG. 8, the multiphase transformer can be arranged on the downstream of a three-phase alternating-current power supply PS.

### Third Embodiment

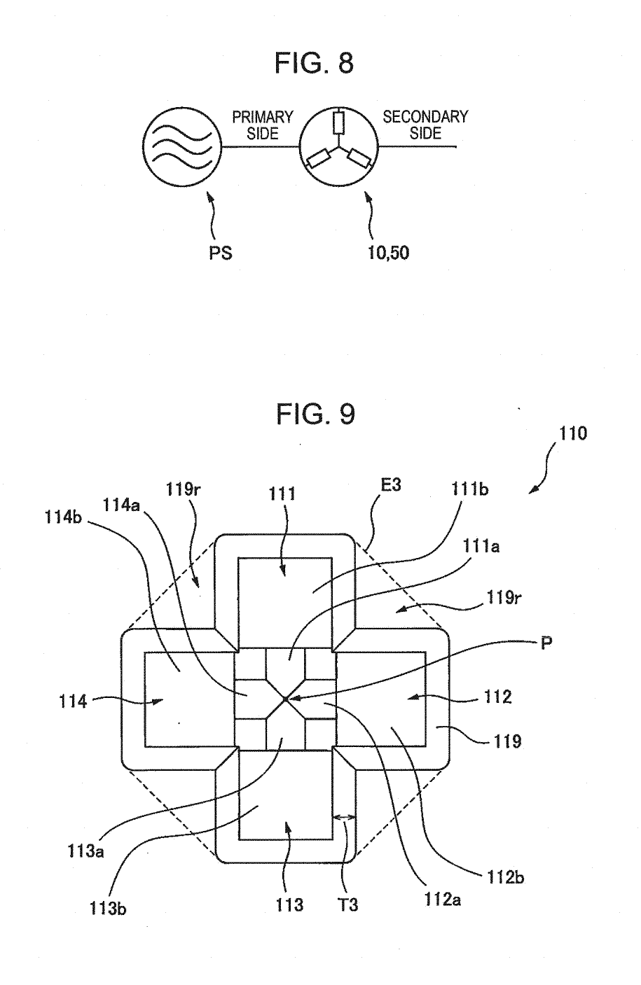

An electromagnetic apparatus according to a third embodiment includes four iron core coils and can be used as a single-phase transformer. Hereinafter, the configuration of a single-phase transformer 110 according to the third embodiment will be described. FIG. 9 is a plan view of the single-phase transformer 110 viewed from above. The single-phase transformer 110 according to the third embodiment includes an outer peripheral iron core 119 and four iron core coils 111 to 114. The single-phase transformer 110 according to the third embodiment is configured such that the number of iron core coils of the multiphase transformer 10 of the first embodiment is increased to four, and the basic concept of configuration is similar to that of the first embodiment. The four iron core coils 111 to 114 have the same configuration as that of each of the iron core coils 15 to 17 of the first embodiment.

The four iron core coils 111 to 114 are arranged at regular intervals in the circumferential direction around the center P of the outer peripheral iron core 119 on the inner side of the outer peripheral iron core 119. In this case, two adjacent center axes among the center axes of the four iron core coils 111 to 114 are intersected at the center P to form an angle of 90 degrees. An end portion on the side of the center P of each of iron cores llla to 114a extended along the center axes of the four iron core coils 111 to 114 has a shape that converges to the center P, and the tip end portion forms an angle of approximately 90 degrees. Thus, the configuration in which the four iron core coils 111 to 114 are surrounded by the outer peripheral iron core 119 is provided, thereby preventing magnetic flux from each of coils 111b to 114b from being leaked to the outer side of the outer peripheral iron core 119.

As illustrated in FIG. 9, the single-phase transformer 110 includes recesses 119r corresponding to a shape in which, among sides of the polygon (octagon) that is formed by connecting the eight corners of the exterior of the outer peripheral iron core 119 as a dashed line E3, a side connecting adjacent iron core coils is recessed toward the center P. It is understood that, with this configuration, the cross-sectional area of the iron core viewed on the cross section defined by cutting the outer peripheral iron core 119 along a plane parallel to the extending directions of the iron core coils 111 to 114 (see FIG. 9) has been considerably reduced, compared with the case where the cross section of the outer peripheral iron core is formed in a polygonal shape depicted by the dashed line E3. That is, the volume and weight of the iron core of the multiphase transformer can be reduced. It is noted that the outer peripheral iron core 119 has a uniform thickness T3 in a planar view in FIG. 9, and surrounds each of the iron core coils 111 to 114 while closely contacting the outer side of each of the iron core coils 111 to 114. Thus, the leakage of magnetic flux from each of the iron core coils 111 to 114 to the outer side of the outer peripheral iron core 119 can be securely suppressed.

As illustrated in FIG. 9, the iron core constituting the single-phase transformer 110 is configured to be divided into four sections. Thus, the outer peripheral iron core 119 is configured to be divided, which makes it possible to efficiently assemble the single-phase transformer 110.

As for the single-phase transformer 110 of the third embodiment, the same effect as that of the multiphase transformer 10 of the first embodiment can be obtained.

As in the third embodiment, the electromagnetic apparatus is configured to include iron core coils whose number is an even number that is four or more, thereby being used as the single-phase transformer. In this single-phase transformer including the iron core coils whose number is an even number that is four or more, each coil can be connected in series or parallel.

According to each embodiment described above, the electromagnetic apparatus can be configured to suppress the flux leakage from the coils and can reduce the volume or weight of the iron cores.

While the invention has been described with reference to specific embodiments, it will be understood, by those skilled in the art, that various changes or modifications may be made thereto without departing from the scope of the following claims.

For example, the number of divisions of the outer peripheral iron core may include various numbers of divisions besides the numbers represented in the aforementioned embodiments.

As for the number of iron core coils arranged on the inner side of the outer peripheral iron core, various numbers including three or more besides the examples represented in the aforementioned embodiments may be included.

The iron core section 9 illustrated in FIG. 2 is integrally structured, but the central leg section 9c may be provided as a separate body separated from other iron core sections. In this case, the iron core section 9 is assembled in such a manner that the central leg section 9c as a separate body is magnetically coupled with the base 9a.

In the aforementioned embodiments, as illustrated in FIG. 1B, the tip ends of the iron cores 15a to 17a of the iron core coils 15 to 17 are in close contact with each other, but the tip ends of the iron cores 15a to 17a may be configured to be joined with each other via a gap.

It is noted that the outer peripheral iron core may not be divided and may be integrally structured.

In addition, various aspects and their effects described below can be provided in order to solve the problems of the present disclosure. It is noted that numbers in parentheses in the explanatory note of the aspects below correspond to reference numbers in the drawings of the present disclosure.

For example, a first aspect of the present disclosure is such that an electromagnetic apparatus includes an outer peripheral iron core (19), at least three leg iron cores (15a to 17a) configured to be arranged at intervals in a circumferential direction on an inner face side of the outer peripheral iron core (19), and a coil (15b to 17b) configured to be wound around each of the at least three leg iron cores (15a to 17a), wherein the at least three leg iron cores (15a to 17a) are arranged such that one end of each of the at least three leg iron cores in a direction of a winding axis (l₀) of the coil (15b to 17b) is magnetically coupled with the outer peripheral iron core (19), and the other end of each of the at least three leg iron cores in the direction of the winding axis (l₀) is magnetically coupled with the other ends of other leg iron cores among the at least three leg iron cores (15a to 17a), and wherein the outer peripheral iron core (19) includes, on an outer face side thereof, a recess (19r) that is recessed toward the inner face side of the outer peripheral iron core (19) in a section corresponding to space between adjacent two leg iron cores in the circumferential direction among the at least three leg iron cores (15a to 17a).

According to the aforementioned first aspect, flux leakage from the coils can be suppressed, and the volume or weight of the iron core can be reduced.

In addition, a second aspect of the present disclosure according to the electromagnetic apparatus (10) of the first aspect is such that the outer peripheral iron core (19) has a part formed to extend in parallel to the winding axis (10o) of the coil (b1b) wound around one leg iron core among the adjacent two leg iron cores in the section corresponding to the space between the adjacent two leg iron cores, and a cross-sectional area defined by cutting the part along an arbitrary plane perpendicular to the winding axis (l₀) of the coil wound around the one leg iron core is constant in a direction parallel to the winding axis (l₀) of the coil wound around the one leg iron core.

In addition, a third aspect of the present disclosure according to the electromagnetic apparatus (10) of the first or second aspect is such that the outer peripheral iron core (19) is formed of a plurality of outer peripheral iron core sections (9).

In addition, a fourth aspect of the present disclosure according to the electromagnetic apparatus (10) of the third aspect is such that the number of the plurality of outer peripheral iron core sections (9) is identical to the number of the at least three leg iron cores (15a to 17a), each of the plurality of outer peripheral iron core sections (9) includes a base (9a) formed to linearly extend, and two side sections (9b, 9d) configured to be extended on the inner face side in such a manner as to form a right angle with respect to the base (9a) at both ends of the base in a linearly extending direction of the base, and each of the at least three leg iron cores (15a to 17a) is connected with the base (9a) between the both ends of each of the plurality of outer peripheral iron core sections (9).

In addition, a fifth aspect of the present disclosure according to the electromagnetic apparatus (10, 50) of any one of the first to fourth aspects is such that the number of the at least three leg iron cores (15a to 17a) is a multiple of three.

In addition, a sixth aspect of the present disclosure according to the electromagnetic apparatus (110) of any one of the first to fourth aspects is such that the number of the at least three leg iron cores (15a to 17a) is an even number that is four or more.

In addition, a seventh aspect of the present disclosure according to the electromagnetic apparatus (10) of any one of the first to sixth aspects is such that the coil (15b to 17b) includes at least one of a primary coil and a secondary coil.

In addition, an eighth aspect of the present disclosure according to the electromagnetic apparatus (10) of any one of the first to seventh aspects is such that the electromagnetic apparatus is a transformer.

1. An electromagnetic apparatus comprising:
an outer peripheral iron core;
at least three leg iron cores configured to be arranged at intervals in a circumferential direction on an inner face side of the outer peripheral iron core; and
a coil configured to be wound around each of the at least three leg iron cores,
wherein the at least three leg iron cores are arranged such that one end of each of the at least three leg iron cores in a direction of a winding axis of the coil is magnetically coupled with the outer peripheral iron core, and other end of each of the at least three leg iron cores in the direction of the winding axis is magnetically coupled with other ends of other leg iron cores among the at least three leg iron cores, and
wherein the outer peripheral iron core includes, on an outer face side thereof, a recess that is recessed toward the inner face side of the outer peripheral iron core in a section corresponding to space between adjacent two leg iron cores in the circumferential direction among the at least three leg iron cores.

2. The electromagnetic apparatus according to claim 1,
wherein the outer peripheral iron core has a part formed to extend in parallel to the winding axis of the coil wound around one leg iron core among the adjacent two leg iron cores in the section corresponding to the space between the adjacent two leg iron cores, and a cross-sectional area defined by cutting the part along an arbitrary plane perpendicular to the winding axis of the coil wound around the one leg iron core is constant in a direction parallel to the winding axis of the coil wound around the one leg iron core.

3. The electromagnetic apparatus according to claim 1,
wherein the outer peripheral iron core is formed of a plurality of outer peripheral iron core sections.

4. The electromagnetic apparatus according to claim 3,
wherein the number of the plurality of outer peripheral iron core sections is identical to the number of the at least three leg iron cores,
each of the plurality of outer peripheral iron core sections includes a base formed to linearly extend, and two side sections configured to be extended on the inner face side in such a manner as to form a right angle with respect to the base at both ends of the base in a linearly extending direction of the base, and
each of the at least three leg iron cores is connected with the base between the both ends of each of the plurality of outer peripheral iron core sections.

5. The electromagnetic apparatus according to claim 1,
wherein the number of the at least three leg iron cores is a multiple of three.

6. The electromagnetic apparatus according to claim 1,
wherein the number of the at least three leg iron cores is an even number that is four or more.

7. The electromagnetic apparatus according to claim 1,
wherein the coil includes at least one of a primary coil and a secondary coil.

8. The electromagnetic apparatus according to claim 1,
wherein the electromagnetic apparatus is a transformer.
